(19) United States
(12) Patent Application Publication
(10) Pub. No.: US 2026/0028464 A1
(43) Pub. Date: Jan. 29, 2026

(54) THERMALLY CONDUCTIVE COMPOSITION AND METHOD FOR PRODUCING THERMALLY CONDUCTIVE COMPOSITION

(71) Applicants: Murata Manufacturing Co., Ltd., Nagaokakyo-shi (JP); Tokyo University of Science Foundation, Tokyo (JP)

(72) Inventors: Hideyasu ONISHI, Nagaokakyo-shi (JP); Asa TAKAHASHI, Nagaokakyo-shi (JP); Yohei KONOSHIMA, Nagaokakyo-shi (JP); Seiichi FURUMI, Tokyo (JP); Naoto IWATA, Tokyo (JP)

(21) Appl. No.: 19/345,123

(22) Filed: Sep. 30, 2025

Related U.S. Application Data
(63) Continuation of application No. PCT/JP2024/012529, filed on Mar. 27, 2024.
(63) Continuation of application No. PCT/JP2023/042429, filed on Nov. 27, 2023.

(30) Foreign Application Priority Data
Apr. 7, 2023 (JP) 2023-063016

(51) Int. Cl. C08K 3/22; C08J 3/20; C08J 3/24; C08K 7/02

(52) U.S. Cl. CPC C08K 3/22; C08J 3/203; C08J 3/24; C08K 7/02; C08J 2301/08; C08K 2003/2227; C08K 2201/003; C08K 2201/005; C08K 2201/016

(57) ABSTRACT

A thermally conductive composition that includes: a matrix having a cross-linked structure; and a filler dispersed in the matrix. The thermal conductivity of the filler is greater than or equal to the thermal conductivity of the matrix. The matrix includes a cellulose derivative in which at least one of hydroxy groups of alkylated cellulose are at least partially substituted with alkanoyl groups and at least one selected from acryloyl groups and methacryloyl groups.

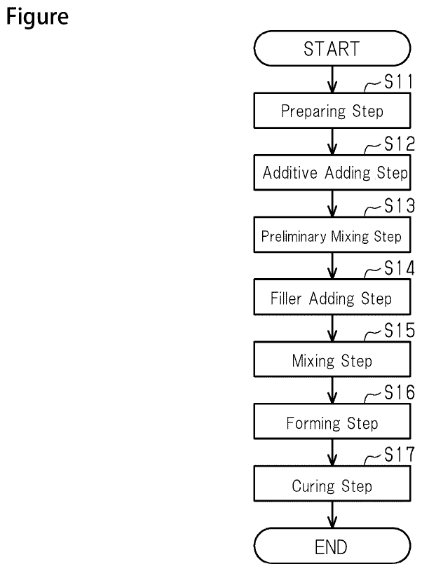

### CROSS REFERENCE TO RELATED APPLICATIONS

The present application is a continuation of International application No. PCT/JP2024/012529, filed Mar. 27, 2024, which claims priority to Japanese Patent Application No. 2023-063016, filed Apr. 7, 2023, and a continuation of International application No. PCT/JP2023/042429, filed Nov. 27, 2023, which claims priority to Japanese Patent Application No. 2023-063016, filed Apr. 7, 2023, the entire contents of each of which are incorporated herein by reference.

### TECHNICAL FIELD

The present disclosure relates to a thermally conductive composition and a method for producing a thermally conductive composition.

### BACKGROUND ART

Patent Literature 1 discloses a thermally conductive composition that includes a matrix and a filler. The material of the matrix is an organopolysiloxane having a crosslinked structure, that is, silicone. The filler is dispersed in the matrix. The material of the filler is a thermally conductive material such as aluminum oxide.

Patent Literature 1: WO2019/004150A1

### SUMMARY OF THE DISCLOSURE

Typical main raw materials for producing silicone are silica and methanol, which is derived from reformed natural gas. That is, the main raw materials of silicone are mineral resources and fossil fuels. Therefore, in the point of the sustainability of main raw materials, there is room for improvement in a thermally conductive composition that uses silicone as the matrix.

To solve the above objective, one aspect of the present disclosure is a thermally conductive composition that includes a matrix having a crosslinked structure, and a filler dispersed in the matrix. A thermal conductivity of the filler is greater than or equal to a thermal conductivity of the matrix. The matrix includes a cellulose derivative in which at least one of hydroxyl groups of alkyl cellulose is substituted with an alkanoyl group and at least one selected from an acryloyl group and a methacryloyl group.

Another aspect of the present disclosure is a thermally conductive composition including a matrix having a crosslinked structure, and a filler dispersed in the matrix. A thermal conductivity of the filler is greater than or equal to a thermal conductivity of the matrix. The matrix includes a cellulose derivative in which at least one of hydroxyl groups of alkyl cellulose is substituted with an allyl group and an alkoxy group.

Another aspect of the present disclosure is a method for producing a thermally conductive composition. The method includes: preparing a cellulose derivative in which at least one of hydroxyl groups of alkyl cellulose is substituted with an alkanoyl group and at least one selected from an acryloyl group and a methacryloyl group; adding a liquid, as an additive, to the cellulose derivative, the liquid having a lower viscosity than the cellulose derivative; mixing the cellulose derivative and the liquid to obtain a preliminary mixture; adding a filler to the preliminary mixture of the cellulose derivative and the additive, the filler having a thermal conductivity that is higher than or equal to a thermal conductivity of the cellulose derivative; and mixing the preliminary mixture and the filler.

In the above structure, the matrix is a cellulose derivative the main backbone of which is alkyl cellulose. Alkyl cellulose may be synthesized using cellulose derived from wood resources as a main raw material. That is, in the structure described above, the raw material forming the matrix of the thermally conductive composition is a composition including a biomass material, which can be sustainably regenerated in nature. The thermally conductive composition is a paste or is rubber-like. Thus, the thermally conductive composition may be used in the same manner as a thermally conductive composition in which the matrix is silicone.

The thermally conductive composition uses a composition containing the biomass-derived material in lieu of silicone.

### BRIEF DESCRIPTION OF THE DRAWING

The FIGURE is a diagram showing the steps in a method for producing a thermally conductive composition.

### DESCRIPTION OF EMBODIMENTS

Embodiment of Thermally Conductive Composition and Method for Producing Thermally Conductive Composition

An embodiment of a thermally conductive composition and a method for producing a thermally conductive composition will now be described with reference to the drawing.

### Thermally Conductive Composition

A thermally conductive composition includes a matrix, a filler, an additive, and other mixed components. The thermally conductive composition is either a solid having rubber-like elasticity or a semi-liquid having both fluidity and viscosity. The thermally conductive composition may have the form of, for example, a sheet, paste, or grease. Hereafter, the ratio of the volume of each component to the total volume of the thermally conductive composition is referred to as a volume concentration. The volume concentration of the matrix is, for example, 20 vol % to 60 vol %. The volume concentration of the filler is, for example, 40 vol % to 80 vol %. In the present embodiment, the volume concentration of the matrix is 50 vol %. The volume concentration of the filler is 49 vol %. The volume concentration of the additive and other mixed components is 1 vol %.

The matrix has a crosslinked structure. The matrix is a cellulose derivative in which at least one of hydroxyl groups of alkyl cellulose is substituted with another functional group. Specifically, in the cellulose derivative, one or more of the hydroxyl groups of the alkyl cellulose is substituted with at least one selected from an acryloyl group and a methacryloyl group. In addition, in the cellulose derivative, one or more of the hydroxyl groups of the alkyl cellulose is substituted with an alkanoyl group.

The alkyl cellulose, which is the base structure of the cellulose derivative, is at least one selected from hydroxypropyl cellulose represented by Chemical Formula 1 shown below and ethyl cellulose represented by Chemical Formula 2 shown below. In Chemical Formula 1, each of x, y, and z is an integer that is greater than or equal to zero. In Chemical Formula 1, for example, x+y+z=4.0. In Chemical Formula 1, m is an integer that is greater than or equal to two. In Chemical Formula 2, m is an integer that is greater than or equal to two.

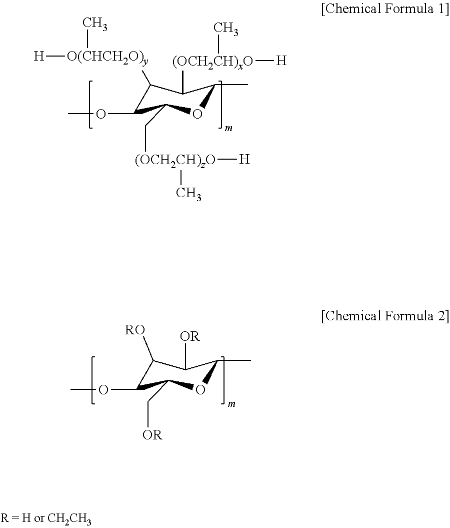

The acryloyl group is a functional group used as a substitute as a result of a reaction of hydroxypropyl cellulose with the compound represented by Chemical Formula 3 shown below. Alternatively, the acryloyl group is a functional group used as a substitute as a result of a reaction of ethyl cellulose with the compound represented by Chemical Formula 3 below. More specifically, the chemical structure of the acryloyl group is represented by Chemical Formula 4. Hereinafter, the acryloyl group represented by Chemical Formula 4 is referred to as the “specified acryloyl group.” In Chemical Formula 4, the symbol “*” denotes a location bonded to the cellulose serving as the base structure. Since the compound represented by Chemical Formula 3 includes a urethane bond, the cellulose derivative having the specified acryloyl group also includes a urethane bond.

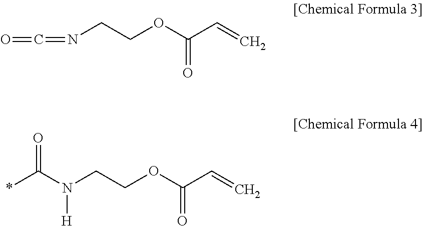

The alkanoyl group is at least one selected from the propionyl group represented by Chemical Formula 5 and the butyryl group, the pentanoyl group, the hexanoyl group, the heptanoyl group, the octanoyl group, the nonanoyl group, and the decanoyl group represented by Chemical Formula 6. That is, the alkanoyl group in the present embodiment is an alkanoyl group derived from a saturated fatty acid having 3 to 10 carbon atoms. The alkanoyl group substitutes for a hydroxyl group of the alkyl cellulose at a location differing from the location of the acryloyl group. In Chemical Formulas 5 and 6, the symbol “*” denotes a location bonded to the cellulose serving as the base structure.

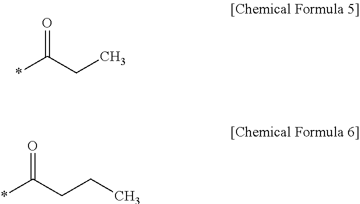

Accordingly, when the alkyl cellulose is hydroxypropyl cellulose, the cellulose derivative is represented by the general formula shown in Chemical Formula 7 below. In Chemical Formula 7, each of x, y, and z is an integer that is greater than or equal to zero. In Chemical Formula 7, for example, x+y+z=4.0. In Chemical Formula 7, m is an integer that is greater than or equal to two. In Chemical Formula 7, R represents one or more substituent groups selected from the specified acryloyl group, the propionyl group, and the alkanoyl group.

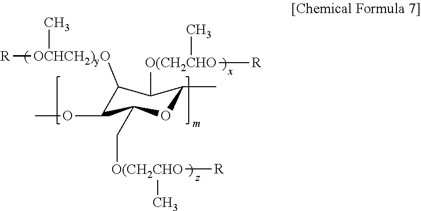

A monomer unit (D-glucopyranose (β-glucose)) of the alkyl cellulose includes three hydroxyl groups. Hereafter, an average number of specified substituent groups that substitute for the three hydroxyl groups is referred to as the “substitution degree” of the specified substituent groups. That is, the substitution degree is expressed as a value that is zero to three, and is an index showing the level at which the specific substituent groups substitute. In the present embodiment, the sum of the substitution degree of the acryloyl group and the substitution degree of the methacryloyl group is preferably 0.1 to 0.6. More preferably, the sum of the substitution degree of the acryloyl group and the substitution degree of the methacryloyl group is 0.1 to 0.3. The substitution degree of the alkanoyl group is preferably 2.0 to 2.9. More preferably, the substitution degree of the alkanoyl group is 2.7 to 2.9. The substitution degree is calculated, for example, from an integral value of a characteristic proton peak of a substituent group using ¹H-NMR analysis.

The filler is dispersed in the matrix. The filler is formed of a thermally conductive material. The thermal conductivity of the filler is greater than or equal to that of the cellulose derivative, which is the matrix. The filler is formed of, for example, at least one material selected from aluminum oxide, magnesium oxide, zinc oxide, iron oxide, quartz, boron nitride, aluminum nitride, silicon carbide, aluminum hydroxide, and cellulose. When cellulose is selected as the filler, it is preferred that cellulose nanofibers be used as the filler. When cellulose nanofibers are selected as the filler, the diameter of the filler is 3 nm to 500 nm. Preferably, the diameter of the filler is 3 nm to 150 nm. More preferably, the diameter of the filler is 3 nm to 20 nm. The aspect ratio of the filler refers to a value obtained by dividing an average fiber length of cellulose nanofibers contained in the filler by an average fiber diameter. The aspect ratio of the filler is greater than or equal to 30. Preferably, the aspect ratio of the filler is greater than or equal to 50. More preferably, the aspect ratio of the filler is greater than or equal to 100. Although the upper limit of the aspect ratio is not particularly limited, it is preferred that the aspect ratio be less than or equal to 500.

### Method for Producing Thermally Conductive Composition

An example of a method for producing a sheet of a thermally conductive composition will now be described.

As shown in the FIGURE, the method for producing the thermally conductive composition includes a preparing step S11, an additive adding step S12, a preliminary mixing step S13, a filler adding step S14, and a mixing step S15. The method for producing the thermally conductive composition further includes a forming step S16 and a curing step S17.

In the preparing step S11, a cellulose derivative, which is the material of the matrix, is prepared. Specifically, in the preparing step S11, a cellulose derivative is prepared in which at least one of the hydroxyl groups of alkyl cellulose is substituted with an alkanoyl group and at least one selected from an acryloyl group and a methacryloyl group. More specifically, at least one alkyl cellulose selected from hydroxypropyl cellulose and ethyl cellulose is first prepared as a starting material. The alkyl cellulose is dissolved in a solvent and is adjusted to a predetermined concentration. The compound represented by Chemical Formula 3 and a compound having at least one of the alkanoyl groups described above is mixed into the alkyl cellulose solution. The alkyl cellulose includes hydroxyl groups. When at least one of the hydroxyl groups is substituted with the substituent groups described above, the cellulose derivative described above is synthesized. Through the steps, the specified acryloyl group is introduced into the alkyl cellulose. Then, polymer networks of the alkyl cellulose are crosslinked through a curing reaction. As a result, rubber-like elasticity is exhibited. The substitution degree of each substituent group may be adjusted in accordance with, for example, the concentration of each of the above-described compounds that is mixed.

Next, the additive adding step S12 is performed. In the additive adding step S12, an additive is mixed into the cellulose derivative prepared in the preparing step S11. Specifically, in the additive adding step S12, the cellulose derivative prepared in the preparing step S11 is added into a container of a stirrer. The stirrer is, for example, a planetary mixer. As additives, a dispersant, a silane coupling agent, and a photopolymerization initiator are added into the container. The additives are liquids having a lower viscosity than the cellulose derivative. When an additive is a solid or a liquid having a higher viscosity than the cellulose derivative, a solvent may be added to improve the compatibility between the additive and the cellulose derivative. If the viscosity of the resulting solution containing the additive becomes lower than the viscosity of the cellulose derivative, the process is equivalent to adding a liquid additive having a lower viscosity than the cellulose derivative. Therefore, the additives described above may be added in the form of a solution or in a state dispersed in a solvent.

Next, the preliminary mixing step S13 is performed. In the preliminary mixing step S13, the cellulose derivative and the additive, which are obtained through the additive adding step S12, are mixed together. Specifically, in the preliminary mixing step S13, the cellulose derivative and the liquid additive added into the container of the stirrer are stirred to be mixed. For example, when the planetary mixer has the capacity of two liters, stirring is performed for one hour at rotation speed of 500 rpm under conditions of room temperature and atmospheric pressure. In the preliminary mixing step S13, the stirring of the cellulose derivative together with the liquid additive improves the compatibility between the cellulose derivative and the components in the additive. As a result, the viscosity of the cellulose derivative is decreased.

Next, the filler adding step S14 is performed. In the filler adding step S14, a filler is added to the preliminary mixture of the cellulose derivative and the additive, which is obtained through the preliminary mixing step S13. As described above, the thermal conductivity of the filler is greater than or equal to that of the cellulose derivative.

Next, the mixing step S15 is performed. In the mixing step S15, the preliminary mixture and the filler are stirred to be mixed. For example, when the planetary mixer has the capacity of two liters, stirring is performed for one hour at rotation speed of 500 rpm, at a reduced pressure of 0.08 MPa, and at room temperature. As a result, the filler is dispersed in the matrix.

Upon completion of the mixing step S15, a thermally conductive composition paste is produced. Even in this state, the material functions as a “thermally conductive composition.” In the forming step S16 and the curing step S17 described below, the thermally conductive composition paste is formed as a sheet and cured.

Next, the forming step S16 is performed. In the forming step S16, the thermally conductive composition paste obtained through the mixing step S15 is formed to have a predetermined thickness. Specifically, in the forming step S16, the thermally conductive composition paste is sandwiched between polyethylene terephthalate films and subjected to a rolling process. As a result, the thermally conductive composition has the form of a sheet having a thickness that is, for example, 2.0 mm to 8.0 mm.

Next, the curing step S17 is performed. In the curing step S17, the thermally conductive composition obtained through the forming step S16 is cured. Specifically, the thermally conductive composition is irradiated for 30 minutes with ultraviolet light having a peak wavelength of 365 nm using an exposure device. The curing reaction of the thermally conductive composition proceeds due to the photopolymerization initiator added in the additive adding step S12. As a result, the thermally conductive composition obtains rubber-like elasticity. After cured, the thermally conductive composition is cut to a desired size. The polyethylene terephthalate films used in the forming step S16 are removed. This produces a sheet of the thermally conductive composition.

### Comparison Test Result According to the First Embodiment

As shown in Tables 1 to 4 below, comparison tests for rubber hardness and thermal conductivity were conducted on the thermally conductive composition described in the first embodiment. The test results of the thermally conductive compositions in Examples 1 to 23 and Comparative Examples 1 to 4 will be described. In the thermally conductive compositions in Examples 1 to 12, Examples 14 to 23, and Comparative Examples 1 to 4, the filler is alumina. The diameter of the filler is 100 um. In the thermally conductive compositions of Examples 1 to 23 and Comparative Examples 1 to 4, the volume concentration of the matrix is 50 vol %. The volume concentration of the filler is 49 vol %.

The volume concentration of the additive and other mixed components is 1 vol %. In addition, in Examples 1 to 23 and Comparative Examples 2 and 4, the thermally conductive compositions have the form of sheets having a thickness of 6 mm.

### EXAMPLES 1 TO 6

The result of the comparison tests of the thermally conductive compositions in Examples 1 to 6 and Comparative Examples 1 and 2 will be described.

TABLE 1

| | Matrix | | | | | | Thermally Conductive Composition | | | |
|---|---|---|---|---|---|---|---|---|---|---|
| | Main Backbone | | | | | | | | | |
| | | Determination | | | | | | | Thermal Conductivity | |
| | | (≥Biomass | Functional Group 1 | | Functional Group 2 | | Rubber Hardness | | Value | Determination |
| | Compound | Ratio | | Substitution | | Substitution | | Determination | (W/m · | (≥0.5 |
| | Name | 30 wt %) | Type | Degree | Type | Degree | Value | (80≥) | K) | W/m · K) |
| Example 1 | Hydroxypropyl | A | Specified | 0.7 | Propionyl | 2.3 | 85 | B | 0.4 | B |
| | Cellulose | | Acryloyl | | Group | | | | | |
| | | | Group | | | | | | | |
| Example 2 | Hydroxypropyl | A | Specified | 0.6 | Propionyl | 2.4 | 80 | A | 1.0 | A |
| | Cellulose | | Acryloyl | | Group | | | | | |
| | | | Group | | | | | | | |
| Example 3 | Hydroxypropyl | A | Specified | 0.3 | Propionyl | 2.7 | 50 | A | 1.4 | A |
| | Cellulose | | Acryloyl | | Group | | | | | |
| | | | Group | | | | | | | |
| Example 4 | Hydroxypropyl | A | Specified | 0.3 | Propionyl | 2.0 | 80 | A | 1.4 | A |
| | Cellulose | | Acryloyl | | Group | | | | | |
| | | | Group | | | | | | | |
| Example 5 | Hydroxypropyl | A | Specified | 0.3 | Propionyl | 1.9 | 81 | B | 1.5 | A |
| | Cellulose | | Acryloyl | | Group | | | | | |
| | | | Group | | | | | | | |
| Example 6 | Hydroxypropyl | A | Specified | 0.1 | Propionyl | 2.9 | 30 | A | 1.3 | A |
| | Cellulose | | Acryloyl | | Group | | | | | |
| | | | Group | | | | | | | |
| Comparative | Hydroxypropyl | A | Specified | 0.0 | Propionyl | 3.0 | Not Solidified | | | |
| Example 1 | Cellulose | | Acryloyl | | Group | | | | | |
| | | | Group | | | | | | | |
| Comparative | Silicone | C | — | — | — | — | 50 | A | 0.9 | A |
| Example 2 | | | | | | | | | | |

The thermally conductive composition of Example 1 is in the form of a sheet as described in the first embodiment. As shown in Table 1, in the thermally conductive composition of Example 1, the matrix is a cellulose derivative in which the hydroxyl groups of hydroxypropyl cellulose are substituted with the specified acryloyl group and the propionyl group. In the thermally conductive composition of Example 1, the substitution degree of the specified acryloyl group is 0.7. The substitution degree of the propionyl group is 2.3. The definition of the substitution degree is the same as described in the first embodiment.

In Tables 1 to 3, in the “Determination” column under “Matrix,” the letter “A” indicates that the biomass content in the matrix is greater than or equal to 30 wt % in terms of weight ratio. The letter “C” indicates that the biomass content in the matrix is less than 30 wt %. Hydroxypropyl cellulose may be synthesized from cellulose fibers produced from, for example, pulp as a raw material. Thus, hydroxypropyl cellulose is a biomass-derived material.

The thermally conductive composition of Example 2 is in the form of a sheet as described in the first embodiment. In the thermally conductive composition of Example 2, the matrix is a cellulose derivative in which the hydroxyl groups of hydroxypropyl cellulose are substituted with the specified acryloyl group and the propionyl group. In the thermally conductive composition of Example 2, the substitution degree of the specified acryloyl group is 0.6. The substitution degree of the propionyl group is 2.4.

The thermally conductive composition of Example 3 is in the form of a sheet as described in the first embodiment. In the thermally conductive composition of Example 3, the matrix is a cellulose derivative in which the hydroxyl groups of hydroxypropyl cellulose are substituted with the specified acryloyl group and the propionyl group. In the thermally conductive composition of Example 3, the substitution degree of the specified acryloyl group is 0.3. The substitution degree of the propionyl group is 2.7.

The thermally conductive composition of Example 4 is in the form of a sheet as described in the first embodiment. In the thermally conductive composition of Example 4, the matrix is a cellulose derivative in which the hydroxyl groups of hydroxypropyl cellulose are substituted with the specified acryloyl group and the propionyl group. In the thermally conductive composition of Example 4, the substitution degree of the specified acryloyl group is 0.3. The substitution degree of the propionyl group is 2.0.

The thermally conductive composition of Example 5 is in the form of a sheet as described in the first embodiment. In the thermally conductive composition of Example 5, the matrix is a cellulose derivative in which the hydroxyl groups of hydroxypropyl cellulose are substituted with the specified acryloyl group and the propionyl group. In the thermally conductive composition of Example 5, the substitution degree of the specified acryloyl group is 0.3. The substitution degree of the propionyl group is 1.9.

The thermally conductive composition of Example 6 is in the form of a sheet as described in the first embodiment. In the thermally conductive composition of Example 6, the matrix is a cellulose derivative in which the hydroxyl groups of hydroxypropyl cellulose are substituted with the specified acryloyl group and the propionyl group. In the thermally conductive composition of Example 6, the substitution degree of the specified acryloyl group is 0.1. The substitution degree of the propionyl group is 2.9.

The thermally conductive composition of Comparative Example 1 is in the form of a sheet as described in the first embodiment. In the thermally conductive composition of Comparative Example 1, the matrix is a cellulose derivative in which the hydroxyl groups of hydroxypropyl cellulose are entirely substituted with the propionyl group. Thus, in the thermally conductive composition of Comparative Example 1, the substitution degree of the specified acryloyl group is 0.0. The substitution degree of the propionyl group is 3.0.

In the thermally conductive composition of Comparative Example 2, the volume concentrations of the matrix, the filler, and the additives are the same as those in Examples 1 to 6. However, in Comparative Example 2, the matrix is an organopolysiloxane, that is, silicone. In addition, the thermally conductive composition of Comparative Example 2 contains, as the additive described in the first embodiment, a thermal polymerization curing agent instead of the photopolymerization initiator. The thermally conductive composition of Comparative Example 2 is produced without performing the preliminary mixing step S13 as described in the method for producing the thermally conductive composition of the first embodiment. The thermally conductive composition of Comparative Example 2 is produced when the additive and the filler are added to and mixed with the matrix and then undergo thermal curing. Specifically, as the curing step S17, a dryer is used to heat for one hour at temperature of 100 degrees.

Comparison tests for rubber hardness were conducted on the thermally conductive compositions of Examples 1 to 6 and Comparative Example 2. Specifically, the rubber hardness of each thermally conductive composition was measured using a Shore A durometer (K-TCL-GS719H manufactured by Teclock Corporation). In the evaluation using the durometer, pressure is applied to a sample by pressing the indenter of the durometer against the surface of the sample. When the applied pressure and the repulsive force of the sample are in equilibrium, the depth of the pressed indenter is shown by a predetermined scale. Thus, the Shore A durometer measures the rubber hardness of the sample. As the Shore A durometer measures a greater rubber hardness of a sample, the sample has a higher elastic modulus, indicating that the sample is hard. As the Shore A durometer measures a smaller rubber hardness of a sample, the sample has a lower elastic modulus, indicating that the sample is soft. In other words, as the rubber hardness becomes smaller, rubber-like elasticity is exhibited more readily. More specifically, for the thermally conductive compositions of Examples 1 to 6 and Comparative Example 2, rubber hardness was measured at five points located at least 12 mm inward from the sample edge at an interval of at least 6 mm between the points. The median or average of the values measured at the five points was considered as the rubber hardness of each sample. The test environment was maintained at a temperature of 23±2 degrees and a humidity of 50±5%. Comparative Example 1 did not cure even after the curing step S17 was performed. Hence, the thermally conductive composition of Comparative Example 1 was excluded from the subjects for measuring rubber hardness.

The result of the rubber hardness comparison tests shows that the rubber hardness of the thermally conductive composition of Example 1 was 85. The rubber hardness of the thermally conductive composition of Example 2 was 80. The rubber hardness of Example 3 was 50. The rubber hardness of the thermally conductive composition of Example 4 was 80. The rubber hardness of the thermally conductive composition of Example 5 was 81. The rubber hardness of the thermally conductive composition of Example 6 was 30. The rubber hardness of Comparative Example 2 was 50.

In Tables 1 to 3, in the “Determination” column of the “Rubber Hardness,” the letter “A” indicates that the rubber hardness was less than or equal to 80. The letter “B” indicates that the rubber hardness is greater than 80. When the rubber hardness of a thermally conductive composition is less than or equal to 80, the thermally conductive composition is acceptable to general use in, for example, an electronic device or an electronic component. In other words, it is preferred that the thermally conductive composition have rubber hardness of 80 or less.

The result of the rubber hardness tests conducted on the thermally conductive compositions of Examples 1 to 3 and Example 6 shows that when the sum of the substitution degree of the acryloyl group and the substitution degree of the propionyl group is 3.0, the rubber hardness of the cellulose derivative decreases as the substitution degree of the acryloyl group decreases and the substitution degree of the propionyl group increases. The result of Comparative Example 1 shows that when the substitution degree of the acryloyl group is 0.0, the cellulose derivative does not cure. Therefore, even though the main raw material of the matrix is a biomass-derived material, the thermally conductive composition of Comparative Example 1 cannot be used in the same manner as when the matrix is formed from silicone. That is, Comparative Example 1 is unsuitable for use as a rubber-like thermally conductive composition. The result of Example 6 indicates that it is preferred that the substitution degree of the acryloyl group to be greater than or equal to 0.1 so that the thermally conductive composition is used in a paste state or a rubber-like state. In other words, it is preferred that the substitution degree of the propionyl group to be less than or equal to 2.9.

The result of the rubber hardness tests conducted on the thermally conductive compositions of Examples 3 to 5 shows that when the substitution degree of the acryloyl group is 0.3, the rubber hardness of the cellulose derivative decreases as the substitution degree of the propionyl group increases. In addition, when the substitution degree of the acryloyl group is less than or equal to 0.3, in order to obtain rubber hardness of 80 or lower, which is suitable for use as a thermally conductive composition, it is preferred that the substitution degree of the propionyl group be greater than or equal to 2.0.

The result of each test conducted on the thermally conductive compositions of Examples 1 to 6 and Comparative Example 2 indicates that the thermally conductive compositions of Examples 2 to 4 and Example 6 obtain a rubber hardness that is sufficient for use as a thermally conductive composition. In particular, the thermally conductive composition of Example 3 obtain a rubber hardness equivalent to that of Comparative Example 2, which includes silicone as a material.

Comparison tests for thermal conductivity were conducted on the thermally conductive compositions of Examples 1 to 6. Specifically, the thermal diffusivity of each thermally conductive composition was measured through a laser flash process using a xenon flash analyzer (TC-9000 manufactured by Advance Riko, Inc.). In the laser flash process, one surface of the sample is heated by being irradiated with a laser beam. In addition, infrared radiation that is emitted from the opposite surface of the sample is detected. The thermal diffusivity of the sample is determined based on the detected value and then is multiplied by the specific heat capacity and the density of the sample to obtain the thermal conductivity. In the present embodiment, the unit of thermal conductivity is expressed as “W/m·K.”

The result of the comparison tests for thermal conductivity shows that the thermal conductivity of the thermally conductive composition of Example 1 was 0.4 W/m·K. The thermal conductivity of the thermally conductive composition of Example 2 was 1.0 W/m·K. The thermal conductivity of the thermally conductive composition of Example 3 was 1.4 W/m·K. The thermal conductivity of the thermally conductive composition of Example 4 was 1.4 W/m·K. The thermal conductivity of the thermally conductive composition of Example 5 was 1.5 W/m·K. The thermal conductivity of the thermally conductive composition of Example 6 was 1.3 W/m·K. The thermal conductivity of the thermally conductive composition of Comparative Example 2 was 0.9 W/m·K. In Tables 1 to 3, in the “Determination” column of the “Thermal Conductivity”, the letter “A” indicates that the thermal conductivity was greater than or equal to 0.5 W/m·K. The letter “B” indicates that the thermal conductivity was less than 0.5 W/m·K.

The result of the thermal conductivity tests conducted on the thermally conductive compositions of Examples 1 to 3 and Example 6 shows that when the sum of the substitution degree of the acryloyl group and the substitution degree of the propionyl group is 3.0, the thermal conductivity of the thermally conductive composition has a tendency to increase as the substitution degree of the acryloyl group decreases and the substitution degree of the propionyl group increases. The thermal conductivity reached substantially its peak when the substitution degree of each substituent group was that set in the thermally conductive composition of Example 3. The result of the tests conducted on Examples 2, 3, and 6 indicates that when the substitution degree of the propionyl group is greater than or equal to 2.4, the thermal conductivity is higher than that of Comparative Example 2, in which silicone is used as the matrix. In other words, it is preferred that the substitution degree of the acryloyl group be less than or equal to 0.6.

The result of the rubber hardness tests conducted on the thermally conductive compositions of Examples 3 to 5 shows that when the substitution degree of the acryloyl group is 0.3, the thermal conductivity of the thermally conductive composition remains substantially constant regardless of variations in the substitution degree of the propionyl group.

The result of each test conducted on the thermally conductive compositions of Examples 1 to 6 and Comparative Example 2 indicates that the thermally conductive compositions of Examples 2 to 6 obtain a thermal conductivity that is sufficient for practical use as a thermally conductive composition. In particular, the thermally conductive compositions of Examples 2 to 6 obtain a higher thermal conductivity than when silicone is used at the same volume concentration of the filler.

The results described above indicate that the thermally conductive compositions of examples 3 and 6, which have a rubber hardness greater than or equal to that of silicone and a higher thermal conductivity than that of silicone, are preferred. More specifically, it is preferred for the cellulose derivative to which the propionyl group is added to have a substitution degree of the acryloyl group that is 0.1 to 0.3 and a substitution degree of the propionyl group that is 2.7 to 2.9. In particular, Example 3 is preferred the most in which the substitution degree of the acryloyl group is 0.3 and the substitution degree of the propionyl group is 2.7.

### EXAMPLES 7 TO 12

The result of comparison tests conducted on the thermally conductive compositions in Examples 7 to 12 and Comparative Examples 3 and 4 will be described.

TABLE 2

| | Matrix | | | | | | Thermally Conductive Composition | | | |
|---|---|---|---|---|---|---|---|---|---|---|
| | Main Backbone | | | | | | | | | |
| | | Determination | | | | | | | Thermal Conductivity | |
| | | (≥Biomass | Functional Group 1 | | Functional Group 2 | | Rubber Hardness | | Value | Determination |
| | Compound | Ratio 30 | | Substitution | | Substitution | | Determination | (W/m · | (≥0.5 |
| | Name | wt %) | Type | Degree | Type | Degree | Value | (80≥) | K) | W/m · K) |
| Example 7 | Hydroxypropyl | A | Specified | 0.7 | Butyryl | 2.3 | 83 | B | 0.4 | B |
| | Cellulose | | Acryloyl | | Group | | | | | |
| | | | Group | | | | | | | |
| Example 8 | Hydroxypropyl | A | Specified | 0.6 | Butyryl | 2.4 | 75 | A | 1.0 | A |
| | Cellulose | | Acryloyl | | Group | | | | | |
| | | | Group | | | | | | | |
| Example 9 | Hydroxypropyl | A | Specified | 0.3 | Butyryl | 2.7 | 45 | A | 1.3 | A |
| | Cellulose | | Acryloyl | | Group | | | | | |
| | | | Group | | | | | | | |
| Example 10 | Hydroxypropyl | A | Specified | 0.3 | Butyryl | 2.0 | 80 | A | 1.1 | A |
| | Cellulose | | Acryloyl | | Group | | | | | |
| | | | Group | | | | | | | |
| Example 11 | Hydroxypropyl | A | Specified | 0.3 | Butyryl | 1.9 | 81 | B | 1.3 | A |
| | Cellulose | | Acryloyl | | Group | | | | | |
| | | | Group | | | | | | | |
| Example 12 | Hydroxypropyl | A | Specified | 0.1 | Butyryl | 2.9 | 25 | A | 1.1 | A |
| | Cellulose | | Acryloyl | | Group | | | | | |
| | | | Group | | | | | | | |
| Comparative | Hydroxypropyl | A | Specified | 0.0 | Butyryl | 3.0 | Not Solidified | | | |
| Example 3 | Cellulose | | Acryloyl | | Group | | | | | |
| | | | Group | | | | | | | |
| Comparative | Silicone | C | — | — | — | — | 50 | A | 0.9 | A |
| Example 4 | | | | | | | | | | |

The thermally conductive composition of Example 7 is in the form of a sheet as described in the first embodiment. As shown in Table 2, in the thermally conductive composition of Example 7, the matrix is a cellulose derivative in which the hydroxyl groups of hydroxypropyl cellulose are substituted with the specified acryloyl group and a butyryl group. In the thermally conductive composition of Example 7, the substitution degree of the specified acryloyl group is 0.7. The substitution degree of the butyryl group is 2.3. The definition of the substitution degree is the same as described in the first embodiment.

The thermally conductive composition of Example 8 is in the form of a sheet as described in the first embodiment. In the thermally conductive composition of Example 8, the matrix is a cellulose derivative in which the hydroxyl groups of hydroxypropyl cellulose are substituted with the specified acryloyl group and the butyryl group. In the thermally conductive composition of Example 8, the substitution degree of the specified acryloyl group is 0.6. The substitution degree of the butyryl group is 2.4.

The thermally conductive composition of Example 9 is in the form of a sheet as described in the first embodiment. In the thermally conductive composition of Example 9, the matrix is a cellulose derivative in which the hydroxyl groups of hydroxypropyl cellulose are substituted with the specified acryloyl group and the butyryl group. In the thermally conductive composition of Example 9, the substitution degree of the specified acryloyl group is 0.3. The substitution degree of the butyryl group is 2.7.

The thermally conductive composition of Example 10 is in the form of a sheet as described in the first embodiment. In the thermally conductive composition of Example 10, the matrix is a cellulose derivative in which the hydroxyl groups of hydroxypropyl cellulose are substituted with the specified acryloyl group and the butyryl group. In the thermally conductive composition of Example 10, the substitution degree of the specified acryloyl group is 0.3. The substitution degree of the butyryl group is 2.0.

The thermally conductive composition of Example 11 is in the form of a sheet as described in the first embodiment. In the thermally conductive composition of Example 11, the matrix is a cellulose derivative in which the hydroxyl groups of hydroxypropyl cellulose are substituted with the specified acryloyl group and the butyryl group. In the thermally conductive composition of Example 11, the substitution degree of the specified acryloyl group is 0.3. The substitution degree of the butyryl group is 1.9.

The thermally conductive composition of Example 12 is in the form of a sheet as described in the first embodiment. In the thermally conductive composition of Example 12, the matrix is a cellulose derivative in which the hydroxyl groups of hydroxypropyl cellulose are substituted with the specified acryloyl group and the butyryl group. In the thermally conductive composition of Example 12, the substitution degree of the specified acryloyl group is 0.1. The substitution degree of the butyryl group is 2.9.

The thermally conductive composition of Comparative Example 3 is in the form of a sheet as described in the first embodiment. In the thermally conductive composition of Comparative Example 3, the matrix is a cellulose derivative in which the hydroxyl groups of hydroxypropyl cellulose are entirely substituted with the butyryl group. Thus, in the thermally conductive composition of Comparative Example 3, the substitution degree of the specified acryloyl group is 0.0. The substitution degree of the butyryl group is 3.0. The thermally conductive composition of Comparative Example 4 has the same configuration as Comparative Example 2. More specifically, in Comparative Example 4, the matrix is an organopolysiloxane, that is, silicone.

Comparison tests for rubber hardness were conducted on the thermally conductive compositions of Examples 7 to 12 and Comparative Example 4. Specific test processes were the same as those of Example 1. Comparative Example 3 did not cure even after the curing step S17 was performed. Hence, the thermally conductive composition of Comparative Example 3 was excluded from the subjects for measuring rubber hardness.

The result of the rubber hardness comparison tests shows that the rubber hardness of the thermally conductive composition of Example 7 was 83. The rubber hardness of the thermally conductive composition of Example 8 was 75. The rubber hardness of Example 9 was 45. The rubber hardness of the thermally conductive composition of Example 10 was 80. The rubber hardness of the thermally conductive composition of Example 11 was 81. The rubber hardness of the thermally conductive composition of Example 12 was 25. The rubber hardness of Comparative Example 4 was 50.

The result of the rubber hardness tests conducted on the thermally conductive compositions of Examples 7 to 9 and Example 12 shows that when the sum of the substitution degree of the acryloyl group and the substitution degree of the butyryl group is 3.0, the rubber hardness of the cellulose derivative decreases as the substitution degree of the acryloyl group decreases and the substitution degree of the butyryl group increases. The result of Comparative Example 3 shows that when the substitution degree of the acryloyl group is 0.0, the cellulose derivative does not cure. Therefore, even though the main raw material of the matrix is a biomass-derived material, the thermally conductive composition of Comparative Example 3 cannot be used in the same manner as when the matrix is formed from silicone. That is, Comparative Example 3 is unsuitable for use as a rubber-like thermally conductive composition. The result of Example 12 indicates that it is preferred that the substitution degree of the acryloyl group to be greater than or equal to 0.1 so that the thermally conductive composition is used in a paste state or a rubber-like state. In other words, it is preferred that the substitution degree of butyryl to be less than or equal to 2.9.

The result of the rubber hardness tests conducted on the thermally conductive compositions of Examples 9 to 11 shows that when the substitution degree of the acryloyl group is 0.3, the rubber hardness of the cellulose derivative decreases as the substitution degree of the butyryl group increases. In addition, when the substitution degree of the acryloyl group is less than or equal to 0.3, in order to obtain rubber hardness of 80 or lower, which is desirable for use as a thermally conductive composition, it is preferred that the substitution degree of the butyryl group be greater than or equal to 2.0.

The result of each test conducted on the thermally conductive compositions of Examples 7 to 12 and Comparative Example 4 indicates that the thermally conductive compositions of Examples 8 to 10 and Example 12 obtain a rubber hardness that is sufficient for use as a thermally conductive composition. The result of the test for rubber hardness conducted on the thermally conductive composition of Example 9 and Comparative Example 4 shows that the thermally conductive composition of Example 9 obtain a rubber hardness equivalent to that of Comparative Example 4, which includes silicone as a material.

Comparison tests for thermal conductivity were conducted on the thermally conductive compositions of Examples 7 to 12. Specific test processes were the same as those of Example 1.

The result of the comparison tests for thermal conductivity shows that the thermal conductivity of the thermally conductive composition of Example 7 was 0.4 W/m·K. The thermal conductivity of the thermally conductive composition of Example 8 was 1.0 W/m·K. The thermal conductivity of the thermally conductive composition of Example 9 was 1.3 W/m·K. The thermal conductivity of the thermally conductive composition of Example 10 was 1.1 W/m·K. The thermal conductivity of the thermally conductive composition of Example 11 was 1.3 W/m·K. The thermal conductivity of the thermally conductive composition of Example 12 was 1.1 W/m·K. The thermal conductivity of the thermally conductive composition of Comparative Example 4 was 0.9 W/m·K.

The result of the thermal conductivity tests conducted on the thermally conductive compositions of Examples 7 to 9 and Example 12 shows that when the sum of the substitution degree of the acryloyl group and the substitution degree of the butyryl group is 3.0, the thermal conductivity of the thermally conductive composition has a tendency to increase as the substitution degree of the acryloyl group decreases and the substitution degree of the butyryl group increases. The thermal conductivity reached substantially its peak when the substitution degree of each substituent group was that set in the thermally conductive composition of Example 9. The result of the tests conducted on Examples 8, 9, and 12 indicates that when the substitution degree of the butyryl group is greater than or equal to 2.4, the thermal conductivity is higher than that of Comparative Example 4, in which silicone is used as the matrix. In other words, it is preferred that the substitution degree of the acryloyl group be less than or equal to 0.6.

The result of the rubber hardness tests conducted on the thermally conductive compositions of Examples 9 to 11 shows that when the substitution degree of the acryloyl group is 0.3, the thermal conductivity of the thermally conductive composition remains substantially constant regardless of variations in the substitution degree of the butyryl group.

The result of each test conducted on the thermally conductive compositions of Examples 7 to 12 and Comparative Example 4 indicates that the thermally conductive compositions of Examples 8 to 12 obtain a thermal conductivity that is sufficient for practical use as a thermally conductive composition. In particular, the thermally conductive compositions of Examples 8 to 12 obtain a higher thermal conductivity than when silicone is used with the same volume concentration of the filler.

The results described above indicate that the thermally conductive compositions of examples 9 and 12, which have a rubber hardness equivalent to that of silicone and a thermal conductivity that is sufficient for use as a thermally conductive composition. More specifically, it is preferred for the cellulose derivative to which the butyryl group is added to have a substitution degree of the acryloyl group that is 0.1 to 0.3 and a substitution degree of the butyryl group that is 2.7 to 2.9. In particular, Example 9 is preferred the most in which the substitution degree of the acryloyl group was 0.3 and the substitution degree of the propionyl group was 2.7.

### EXAMPLE 13

The result of comparison tests conducted on the thermally conductive compositions in Example 13 will be described.

TABLE 3

| | Matrix | | | | | | Thermally Conductive Composition | | | |
|---|---|---|---|---|---|---|---|---|---|---|
| | Main Backbone | | | | | | | | | |
| | | Determination | | | | | | | Thermal Conductivity | |
| | | (≥Biomass | Functional Group 1 | | Functional Group 2 | | Rubber Hardness | | Value | Determination |
| | Compound | Ratio | | Substitution | | Substitution | | Determination | (W/m · | (≥0.5 |
| | Name | 30 wt %) | Type | Degree | Type | Degree | Value | (80≥) | K) | W/m · K) |
| Example 13 | Hydroxypropyl | A | Specified | 0.3 | Propionyl | 2.7 | 45 | A | 0.5 | A |
| | Cellulose | | Acryloyl | | Group | | | | | |
| | | | Group | | | | | | | |

The thermally conductive composition of Example 13 is in the form of a sheet as described in the first embodiment. In the thermally conductive composition of Example 13, the matrix is a cellulose derivative in which the hydroxyl groups of hydroxypropyl cellulose are substituted with the specified acryloyl group and the propionyl group. In the thermally conductive composition of Example 13, the substitution degree of the specified acryloyl group is 0.3. The substitution degree of the propionyl group is 2.7. In the thermally conductive composition of Example 13, the filler is cellulose. More specifically, the filler includes cellulose nanofibers. The diameter of the filler is 3 nm to 500 nm. In the thermally conductive composition of Example 13, the aspect ratio of the filler is greater than or equal to 30. That is, the thermally conductive composition of Example 13 is obtained by replacing the filler of the thermally conductive composition of Example 3 with cellulose nanofibers.

A comparison test for rubber hardness was conducted on the thermally conductive composition of Example 13. Specific test processes were the same as those of Example 1. The result of the comparison test shows that the rubber hardness of the thermally conductive composition of Example 13 was 45. The result of the comparison tests conducted on the thermally conductive compositions of Examples 3 and 13 indicates that when the material of the filler is cellulose nanofibers, the rubber hardness of the thermally conductive composition is improved.

A comparison test for thermal conductivity was conducted on the thermally conductive compositions of Example 13. Specific test processes were the same as those of Example 1. The result of the comparison test for thermal conductivity shows that the thermal conductivity of the thermally conductive composition of Example 13 was 0.5 W/m·K. The result of the comparison tests conducted on the thermally conductive compositions of Examples 3 and 13 indicates that even when the material of the matrix and the filler is cellulose, the rubber hardness is sufficient for used as a thermally conductive composition.

### EXAMPLES 14 TO 23

The result of comparison tests conducted on the thermally conductive compositions in Examples 14 to 23 will be described.

TABLE 4

| | Matrix | | | | | | Thermally Conductive Composition | | | |
|---|---|---|---|---|---|---|---|---|---|---|
| | Main Backbone | | | | | | | | | |
| | | Determination | | | | | | | Thermal Conductivity | |
| | | (≥Biomass | Functional Group 1 | | Functional Group 2 | | Rubber Hardness | | Value | Determination |
| | Compound | Ratio | | Substitution | | Substitution | | Determination | (W/m · | (≥1.0 |
| | Name | 30 wt %) | Type | Degree | Type | Degree | Value | (80≥) | K) | W/m · K) |
| Example 14 | Hydroxypropyl | A | Specified | 0.2 | Pentanoyl | 2.8 | 43 | A | 1.3 | A |
| | Cellulose | | Acryloyl | | Group | | | | | |
| | | | Group | | | | | | | |
| Example15 | Hydroxypropyl | A | Specified | 0.3 | Pentanoyl | 2.1 | 42 | A | 1.3 | A |
| | Cellulose | | Acryloyl | | Group | | | | | |
| | | | Group | | | | | | | |
| Example 16 | Hydroxypropyl | A | Specified | 0.2 | Hexanoyl | 2.8 | 40 | A | 1.4 | A |
| | Cellulose | | Acryloyl | | Group | | | | | |
| | | | Group | | | | | | | |
| Example 17 | Hydroxypropyl | A | Specified | 0.2 | Heptanoyl | 2.8 | 38 | A | 1.3 | A |
| | Cellulose | | Acryloyl | | Group | | | | | |
| | | | Group | | | | | | | |
| Example 18 | Hydroxypropyl | A | Specified | 0.2 | Octanoyl | 2.8 | 35 | A | 1.2 | A |
| | Cellulose | | Acryloyl | | Group | | | | | |
| | | | Group | | | | | | | |
| Example 19 | Hydroxypropyl | A | Specified | 0.2 | Nonanoyl | 2.8 | 31 | A | 1.1 | A |
| | Cellulose | | Acryloyl | | Group | | | | | |
| | | | Group | | | | | | | |
| Example 20 | Hydroxypropyl | A | Specified | 0.2 | Decanoyl | 2.8 | 31 | A | 1.1 | A |
| | Cellulose | | Acryloyl | | Group | | | | | |
| | | | Group | | | | | | | |
| Example 21 | Hydroxypropyl | A | Specified | 0.3 | Decanoyl | 2.1 | 42 | A | 1.3 | A |
| | Cellulose | | Acryloyl | | Group | | | | | |
| | | | Group | | | | | | | |
| Example 22 | Ethyl | A | Specified | 0.2 | Pentanoyl | 2.8 | 73 | A | 1.5 | A |
| | Cellulose | | Acryloyl | | Group | | | | | |
| | | | Group | | | | | | | |
| Example 23 | Ethyl | A | Specified | 0.2 | Hexanoyl | 2.8 | 69 | A | 1.4 | A |
| | Cellulose | | Acryloyl | | Group | | | | | |
| | | | Group | | | | | | | |

The thermally conductive composition of Example 14 is that described in the first embodiment. As shown in Table 4, in the thermally conductive composition of Example 14, the matrix is a cellulose derivative in which the hydroxyl groups of hydroxypropyl cellulose are substituted with the specified acryloyl group and the pentanoyl group. In the thermally conductive composition of Example 14, the substitution degree of the specified acryloyl group is 0.2. The substitution degree of the pentanoyl group is 2.8.

In Tables 4 to 5, in the “Evaluation” column under “Matrix,” the letter “A” indicates that the biomass content in the matrix is greater than or equal to 30 wt % in terms of weight ratio. Th letter “C” indicates that the biomass content in the matrix is less than 30 wt %.

The thermally conductive composition of Example 15 is that described in the first embodiment. As shown in Table 4, in the thermally conductive composition of Example 15, the matrix is a cellulose derivative in which the hydroxyl groups of hydroxypropyl cellulose are substituted with the specified acryloyl group and the pentanoyl group. In the thermally conductive composition of Example 15, the substitution degree of the specified acryloyl group is 0.3. The substitution degree of the pentanoyl group is 2.1.

The thermally conductive composition of Example 16 is that described in the first embodiment. As shown in Table 4, in the thermally conductive composition of Example 16, the matrix is a cellulose derivative in which the hydroxyl groups of hydroxypropyl cellulose are substituted with the specified acryloyl group and the hexanoyl group. In the thermally conductive composition of Example 16, the substitution degree of the specified acryloyl group is 0.2. The substitution degree of the hexanoyl group is 2.8.

The thermally conductive composition of Example 17 is that described in the first embodiment. As shown in Table 4, in the thermally conductive composition of Example 17, the matrix is a cellulose derivative in which the hydroxyl groups of hydroxypropyl cellulose are substituted with the specified acryloyl group and the heptanoyl group. In the thermally conductive composition of Example 17, the substitution degree of the specified acryloyl group is 0.2. The substitution degree of the heptanoyl group is 2.8.

The thermally conductive composition of Example 18 is that described in the first embodiment. As shown in Table 4, in the thermally conductive composition of Example 18, the matrix is a cellulose derivative in which the hydroxyl groups of hydroxypropyl cellulose are substituted with the specified acryloyl group and the octanoyl group. In the thermally conductive composition of Example 18, the substitution degree of the specified acryloyl group is 0.2. The substitution degree of the octanoyl group is 2.8.

The thermally conductive composition of Example 19 is that described in the first embodiment. As shown in Table 4, in the thermally conductive composition of Example 19, the matrix is a cellulose derivative in which the hydroxyl groups of hydroxypropyl cellulose are substituted with the specified acryloyl group and the nonanoyl group. In the thermally conductive composition of Example 19, the substitution degree of the specified acryloyl group is 0.2. The substitution degree of the nonanoyl group is 2.8.

The thermally conductive composition of Example 20 is that described in the first embodiment. As shown in Table 4, in the thermally conductive composition of Example 20, the matrix is a cellulose derivative in which the hydroxyl groups of hydroxypropyl cellulose are substituted with the specified acryloyl group and the decanoyl group. In the thermally conductive composition of Example 20, the substitution degree of the specified acryloyl group is 0.2. The substitution degree of the decanoyl group is 2.8.

The thermally conductive composition of Example 21 is that described in the first embodiment. As shown in Table 4, in the thermally conductive composition of Example 21, the matrix is a cellulose derivative in which the hydroxyl groups of hydroxypropyl cellulose are substituted with the specified acryloyl group and the decanoyl group. In the thermally conductive composition of Example 21, the substitution degree of the specified acryloyl group is 0.3. The substitution degree of the decanoyl group is 2.1.

The thermally conductive composition of Example 22 is that described in the first embodiment. As shown in Table 4, in the thermally conductive composition of Example 22, the matrix is a cellulose derivative in which the hydroxyl groups of ethyl cellulose are substituted with the specified acryloyl group and the pentanoyl group. In the thermally conductive composition of Example 22, the substitution degree of the specified acryloyl group is 0.2. The substitution degree of the pentanoyl group is 2.8.

The thermally conductive composition of Example 23 is that described in the first embodiment. As shown in Table 4, in the thermally conductive composition of Example 23, the matrix is a cellulose derivative in which the hydroxyl groups of ethyl cellulose are substituted with the specified acryloyl group and the hexanoyl group. In the thermally conductive composition of Example 23, the substitution degree of the specified acryloyl group is 0.2. The substitution degree of the hexanoyl group is 2.8.

A comparison test for rubber hardness was conducted on the thermally conductive composition of Examples 14 to 23. Specific test processes were the same as those of Example 1 in the first embodiment. In Tables 4 to 5, in the “Evaluation” column of the “Rubber Hardness,” the letter “A” indicates that the rubber hardness was less than or equal to 80.

The result of the rubber hardness comparison tests shows that the rubber hardness of the thermally conductive composition of Example 14 was 43. The rubber hardness of the thermally conductive composition of Example 15 was 42. The rubber hardness of the thermally conductive composition of Example 16 was 40. The rubber hardness of the thermally conductive composition of Example 17 was 38. The rubber hardness of the thermally conductive composition of Example 18 was 35. The rubber hardness of the thermally conductive composition of Example 19 was 31. The rubber hardness of the thermally conductive composition of Example 20 was 31. The rubber hardness of the thermally conductive composition of Example 21 was 42. The rubber hardness of the thermally conductive composition of Example 22 was 73. The rubber hardness of the thermally conductive composition of Example 23 was 69.

Comparison tests for thermal conductivity were conducted on the thermally conductive compositions of Examples 14 to 23. Specific test processes were the same as those of Example 1 in the first embodiment. In Tables 1 to 3, in the “Evaluation” column of the “Thermal Conductivity”, the letter “A” indicates that the thermal conductivity was greater than or equal to 1.0 W/m·K.

The result of the comparison test for thermal conductivity shows that the thermal conductivity of the thermally conductive composition of Example 14 was 1.3 W/m·K. The thermal conductivity of the thermally conductive composition of Example 15 was 1.3 W/m·K. The thermal conductivity of the thermally conductive composition of Example 16 was 1.4 W/m·K. The thermal conductivity of the thermally conductive composition of Example 17 was 1.3 W/m·K. The thermal conductivity of the thermally conductive composition of Example 18 was 1.2 W/m·K. The thermal conductivity of the thermally conductive composition of Example 19 was 1.1 W/m·K. The thermal conductivity of the thermally conductive composition of Example 20 was 1.1 W/m·K. The thermal conductivity of the thermally conductive composition of Example 21 was 1.3 W/m·K. The thermal conductivity of the thermally conductive composition of Example 22 was 1.5 W/m·K. The thermal conductivity of the thermally conductive composition of Example 23 was 1.4 W/m·K.

### Advantages of the First Embodiment

(1-1) In the first embodiment, the matrix of the thermally conductive composition is a cellulose derivative, the main backbone of which is alkyl cellulose. Alkyl cellulose may be synthesized using cellulose derived from wood resources as a main raw material. That is, in the structure described above, the raw material forming the matrix of the thermally conductive composition is a composition including a biomass material, which can be sustainably regenerated in nature.
(1-2) In the first embodiment, the matrix is a cellulose derivative in which at least one of the hydroxyl groups of alkyl cellulose is substituted with an alkanoyl group and at least one selected from an acryloyl group and a methacryloyl group. The cellulose derivative is paste before being cured. The cellulose derivative changes to be rubber-like when cured. In other words, the cellulose derivative can be used in the same manner as silicone and similar materials.
(1-3) In the first embodiment, the main backbone of the cellulose derivative is an alkyl cellulose that includes at least one selected from hydroxypropyl cellulose and ethyl cellulose. Hydroxypropyl cellulose is relatively easy to produce and is also inexpensive and readily available. Hence, hydroxypropyl cellulose is suitable for the main backbone of the cellulose derivative.
(1-4) In the first embodiment, the cellulose derivative includes a urethane bond. The urethane bond increases the physical length of a substituent group. As a result, the density between the main backbones of the cellulose derivative is reduced. Thus, when cured, the matrix has flexibility. In other words, the matrix obtains rubber-like elasticity more readily.
(1-5) In the first embodiment, the substitution degree of the acryloyl group and the methacryloyl group is 0.1 to 0.6. The substitution degree of alkanoyl group is 2.0 to 2.9. The result of the comparison tests described above indicates that these substitution degrees allow the thermally conductive composition to have a thermal conductivity sufficient for practical use while obtaining sufficient rubber hardness.
(1-6) In the first embodiment, the alkanoyl group includes at least one selected from the propionyl group, the butyryl group, the pentanoyl group, the hexanoyl group, the heptanoyl group, the octanoyl group, the nonanoyl group, and the decanoyl group. The result of the comparison tests described above indicates that when the alkanoyl groups described above are selected, the thermally conductive composition readily obtains both sufficient rubber hardness and sufficient thermal conductivity.
(1-7) In the first embodiment, the filler in the thermally conductive composition of Example 13 contains cellulose. Thus, the proportion of biomass material in the thermally conductive composition is further increased. This reduces the environmental impact during manufacturing and disposal processes.
(1-8) In the first embodiment, in the preliminary mixing step S13, the additive is mixed with the cellulose derivative together with the solution. This decreases the viscosity of the cellulose derivative, thereby facilitating the mixing of the preliminary mixture with the filler in the mixing step S15.

### Second Embodiment of Thermally Conductive Composition and Method for Producing Thermally Conductive Composition

A second embodiment of a thermally conductive composition and a method for producing a thermally conductive composition will now be described. The description of the same configurations as those in the first embodiment and the functional groups described above will be partially omitted. The definition of the substitution degree in the second embodiment is the same as that in the first embodiment. The compositions and composition ratio of the thermally conductive composition in the second embodiment are the same as those in the first embodiment. That is, the thermally conductive composition includes a matrix, a filler, an additive, and other mixed components. The thermally conductive composition is either a solid having rubber-like elasticity or a semi-liquid having both fluidity and viscosity. The matrix has a crosslinked structure. The filler is dispersed in the matrix. The material of the filler is the same as that in the first embodiment and contains cellulose. The thermal conductivity of the filler is greater than or equal to the thermal conductivity of the matrix.

The thermally conductive composition of the second embodiment differs from that of the first embodiment in functional group that substitutes for a hydroxyl group of alkyl cellulose. In the second embodiment, the alkyl cellulose is at least one selected from the hydroxypropyl cellulose represented by Chemical Formula 1 and the ethyl cellulose represented by Chemical Formula 2.

Specifically, in the thermally conductive composition of the second embodiment, the matrix is a cellulose derivative in which at least one of hydroxyl groups of alkyl cellulose is substituted with an allyl group and an alkanoyl group.

More specifically, in the second embodiment, at least one of hydroxyl groups of alkyl cellulose is substituted with the allyl group represented by Chemical Formula 8 shown below. In Chemical Formula 8, the symbol “*” denotes a location bonded to the cellulose serving as the base structure.

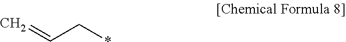 [SMILES: *CC=C]

In the second embodiment, the alkoxy group substitutes for a hydroxyl group of the alkyl cellulose at a location different from the location of the allyl group. The alkoxy group includes at least one selected from a pentyloxy group, a hexyloxy group, a heptyloxy group, an octyloxy group, a nonanoyloxy group, and a decanoyloxy group represented by the Chemical Formula 9 shown below. That is, in the present embodiment, the alkanoyl group has 5 to 10 carbon atoms.

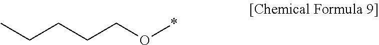 [SMILES: *OCCCCC]

In the second embodiment, the sum of the substitution degree of the allyl group is 0.1 to 0.6. More preferably, the sum of the substitution degree of the allyl group is 0.1 to 0.3. The substitution degree of alkoxy group is 2.0 to 2.9. More preferably, the substitution degree of the alkoxy group is 2.7 to 2.9.

### Method for Producing Thermally Conductive Composition According to the Second Embodiment

The method for producing the thermally conductive composition according to the second embodiment will now be described. In the method for producing the thermally conductive composition according to the second embodiment, the components of the matrix prepared in the preparing step S11 differs from those of the first embodiment. Specifically, the preparing step of the second embodiment prepares a cellulose derivative in which at least one of hydroxy groups of alkyl cellulose is substituted with an allyl group and an alkoxy group. The alkyl cellulose is at least one selected from hydroxypropyl cellulose and ethyl cellulose. A specific process of synthesizing the cellulose derivative in the preparing step is the same as that of the first embodiment. In the producing method of the second embodiment, the steps after the preparing step are the same as those of the first embodiment and thus will not be described.

### Comparison Test Result According to the Second Embodiment

As shown in Table 5 below, comparison tests for rubber hardness and thermal conductivity were conducted on the thermally conductive composition described in the second embodiment. The test results of the thermally conductive compositions in Examples 24 to 33 will be described.

In the thermally conductive compositions in Examples 24 to 33, the material of filler is alumina. The diameter of the filler is 100 μm. The volume concentration of the matrix is 50 vol %. The volume concentration of the filler is 49 vol %. The volume concentration of the additive and other mixed components is 1 vol %. In addition, in Examples 14 to 33, the thermally conductive compositions have the form of sheets having a thickness of 6 mm.

TABLE 5

| | Matrix | | | | | | Thermally Conductive Composition | | | |
|---|---|---|---|---|---|---|---|---|---|---|
| | Main Backbone | | | | | | | | | |
| | | Determination | Functional Group 1 | | | | | | Thermal Conductivity | |
| | | (≥Biomass | | Substi- | Functional Group 2 | | Rubber Hardness | | Value | Determination |
| | Compound | Ratio | | tution | | Substitution | | Determination | (W/m · | (≥1.0 |
| | Name | 30 wt %) | Type | Degree | Type | Degree | Value | (80≥) | K) | W/m · K) |
| Example 24 | Hydroxypropyl | A | Allyl | 0.2 | Pentyloxy | 2.8 | 34 | A | 1.4 | A |
| | Cellulose | | Group | | Group | | | | | |
| Example 25 | Hydroxypropyl | A | Allyl | 0.3 | Pentyloxy | 2.1 | 43 | A | 1.4 | A |
| | Cellulose | | Group | | Group | | | | | |
| Example 26 | Hydroxypropyl | A | Allyl | 0.2 | Hexyloxy | 2.8 | 33 | A | 1.4 | A |
| | Cellulose | | Group | | Group | | | | | |
| Example 27 | Hydroxypropyl | A | Allyl | 0.2 | Heptyloxy | 2.8 | 31 | A | 1.3 | A |
| | Cellulose | | Group | | Group | | | | | |
| Example 28 | Hydroxypropyl | A | Allyl | 0.2 | Octyloxy | 2.8 | 30 | A | 1.2 | A |
| | Cellulose | | Group | | Group | | | | | |
| Example 29 | Hydroxypropyl | A | Allyl | 0.2 | Nonanoyloxy | 2.8 | 28 | A | 1.2 | A |
| | Cellulose | | Group | | Group | | | | | |
| Example 30 | Hydroxypropyl | A | Allyl | 0.2 | Decanoyloxy | 2.8 | 26 | A | 1.1 | A |
| | Cellulose | | Group | | Group | | | | | |
| Example 31 | Hydroxypropyl | A | Allyl | 0.3 | Decanoyloxy | 2.1 | 26 | A | 1.1 | A |
| | Cellulose | | Group | | Group | | | | | |
| Example 32 | Ethyl | A | Allyl | 0.2 | Pentyloxy | 2.8 | 51 | A | 1.3 | A |
| | Cellulose | | Group | | Group | | | | | |
| Example 33 | Ethyl | A | Allyl | 0.2 | Hexyloxy | 2.8 | 48 | A | 1.3 | A |
| | Cellulose | | Group | | Group | | | | | |

The thermally conductive composition of Example 24 is that described in the second embodiment. As shown in Table 5, in the thermally conductive composition of Example 24, the matrix is a cellulose derivative in which the hydroxyl groups of hydroxypropyl cellulose are substituted with the allyl group and the pentyloxy group. In the thermally conductive composition of Example 24, the substitution degree of the allyl group is 0.2. The substitution degree of the pentyloxy group is 2.8.

The thermally conductive composition of Example 25 is that described in the second embodiment. As shown in Table 5, in the thermally conductive composition of Example 25, the matrix is a cellulose derivative in which the hydroxyl groups of hydroxypropyl cellulose are substituted with the allyl group and the pentyloxy group. In the thermally conductive composition of Example 25, the substitution degree of the allyl group is 0.3. The substitution degree of the pentyloxy group is 2.1.

The thermally conductive composition of Example 26 is that described in the second embodiment. As shown in Table 5, in the thermally conductive composition of

Example 26, the matrix is a cellulose derivative in which the hydroxyl groups of hydroxypropyl cellulose are substituted with the allyl group and the hexyloxy group. In the thermally conductive composition of Example 26, the substitution degree of the allyl group is 0.2. The substitution degree of the hexyloxy group is 2.8.

The thermally conductive composition of Example 27 is that described in the second embodiment. As shown in Table 5, in the thermally conductive composition of Example 27, the matrix is a cellulose derivative in which the hydroxyl groups of hydroxypropyl cellulose are substituted with the allyl group and the heptyloxy group. In the thermally conductive composition of Example 27, the substitution degree of the allyl group is 0.2. The substitution degree of the heptyloxy group is 2.8.

The thermally conductive composition of Example 28 is that described in the second embodiment. As shown in Table 5, in the thermally conductive composition of Example 28, the matrix is a cellulose derivative in which the hydroxyl groups of hydroxypropyl cellulose are substituted with the allyl group and the octyloxy group. In the thermally conductive composition of Example 28, the substitution degree of the allyl group is 0.2. The substitution degree of the octyloxy group is 2.8.

The thermally conductive composition of Example 29 is that described in the second embodiment. As shown in Table 5, in the thermally conductive composition of Example 29, the matrix is a cellulose derivative in which the hydroxyl groups of hydroxypropyl cellulose are substituted with the allyl group and the nonanoyloxy group. In the thermally conductive composition of Example 29, the substitution degree of the allyl group is 0.2. The substitution degree of the nonanoyloxy group is 2.8.

The thermally conductive composition of Example 30 is that described in the second embodiment. As shown in Table 5, in the thermally conductive composition of Example 30, the matrix is a cellulose derivative in which the hydroxyl groups of hydroxypropyl cellulose are substituted with the allyl group and the decanoyloxy group. In the thermally conductive composition of Example 30, the substitution degree of the allyl group is 0.2. The substitution degree of the decanoyloxy group is 2.8.

The thermally conductive composition of Example 31 is that described in the second embodiment. As shown in Table 5, in the thermally conductive composition of Example 31, the matrix is a cellulose derivative in which the hydroxyl groups of hydroxypropyl cellulose are substituted with the allyl group and the decanoyloxy group. In the thermally conductive composition of Example 31, the substitution degree of the allyl group is 0.3. The substitution degree of the decanoyloxy group is 2.1.

The thermally conductive composition of Example 32 is that described in the second embodiment. As shown in Table 5, in the thermally conductive composition of Example 32, the matrix is a cellulose derivative in which the hydroxyl groups of ethyl cellulose are substituted with the allyl group and the pentyloxy group. In the thermally conductive composition of Example 32, the substitution degree of the allyl group is 0.2. The substitution degree of the pentyloxy group is 2.8.

The thermally conductive composition of Example 33 is that described in the second embodiment. As shown in Table 5, in the thermally conductive composition of Example 33, the matrix is a cellulose derivative in which the hydroxyl groups of ethyl cellulose are substituted with the allyl group and the hexyloxy group. In the thermally conductive composition of Example 33, the substitution degree of the allyl group is 0.2. The substitution degree of the hexyloxy group is 2.8.

A comparison test for rubber hardness was conducted on the thermally conductive composition of Examples 24 to 33. Specific test processes were the same as those of Example 1 in the first embodiment. The result of the rubber hardness comparison tests shows that the rubber hardness of the thermally conductive composition of Example 24 was 34. The rubber hardness of the thermally conductive composition of Example 25 was 43. The rubber hardness of the thermally conductive composition of Example 26 was 33. The rubber hardness of the thermally conductive composition of Example 27 was 31. The rubber hardness of the thermally conductive composition of Example 28 was 30. The rubber hardness of the thermally conductive composition of Example 29 was 28. The rubber hardness of the thermally conductive composition of Example 30 was 26. The rubber hardness of the thermally conductive composition of Example 31 was 26. The rubber hardness of the thermally conductive composition of Example 32 was 51. The rubber hardness of the thermally conductive composition of Example 33 was 48.

Comparison tests for thermal conductivity were conducted on the thermally conductive compositions of Examples 24 to 33. Specific test processes were the same as those of Example 1 in the first embodiment. The result of the comparison test for thermal conductivity shows that the thermal conductivity of the thermally conductive composition of Example 24 was 1.4 W/m·K. The thermal conductivity of the thermally conductive composition of Example 25 was 1.4 W/m·K. The thermal conductivity of the thermally conductive composition of Example 26 was 1.4 W/m·K. The thermal conductivity of the thermally conductive composition of Example 27 was 1.3 W/m·K. The thermal conductivity of the thermally conductive composition of Example 28 was 1.2 W/m·K. The thermal conductivity of the thermally conductive composition of Example 29 was 1.2 W/m·K. The thermal conductivity of the thermally conductive composition of Example 30 was 1.1 W/m·K. The thermal conductivity of the thermally conductive composition of Example 31 was 1.1 W/m·K. The thermal conductivity of the thermally conductive composition of Example 32 was 1.3 W/m·K. The thermal conductivity of the thermally conductive composition of Example 33 was 1.3 W/m·K.

### Advantages of the Second Embodiment

The second embodiment has the following advantages in addition to (1-1), (1-3), and (1-8) described above.

(2-1) In the second embodiment, the matrix is a cellulose derivative in which at least one of hydroxyl groups of alkyl cellulose is substituted with the allyl group and the alkoxy group. The cellulose derivative is paste before being cured. The cellulose derivative changes to be rubber-like when cured. In other words, the cellulose derivative can be used in the same manner as silicone and similar materials.

(2-2) In the second embodiment, the substitution degree of the allyl group is 0.1 to 0.6. The substitution degree of alkoxy group is 2.0 to 2.9. The alkoxy group includes at least one selected from the pentyloxy group, the hexyloxy group, the heptyloxy group, the octyloxy group, the nonanoyloxy group, and the decanoyloxy group. The result of the comparison tests described above indicates that these substitution degrees allow the thermally conductive composition to have a thermal conductivity sufficient for practical use while obtaining sufficient rubber hardness.

### Modified Examples

The first embodiment, the second embodiment, and the following modified examples may be combined as long as the combined modified examples remain technically consistent with each other.

The shape of the thermally conductive composition is not limited to those of the embodiments. The thermally conductive composition paste may be cured to have any shape and any size. Alternatively, the thermally conductive composition paste may be used without curing.

The volume concentration of the matrix, the volume concentration of the filler, and the volume concentration of the additives and other mixed components are not limited to those of the embodiments. Even when the volume concentration of each component differs from those of the embodiments, as long as the cellulose derivative described in the embodiments is used as the matrix of the thermally conductive composition, the matrix of the thermally conductive composition has a higher thermal conductivity than that of silicone or the like. In other words, at least the advantage (1-1) is obtained even when the volume concentration of each component differs.

In the embodiments, the specified acryloyl group does not necessarily have to be selected as the acryloyl group or methacryloyl group. Other acryloyl groups or methacryloyl groups may also be used to produce a thermally conductive composition that is a solid having rubber-like elasticity or a solid having both fluidity and viscosity.

The cellulose derivative does not necessarily have to include a urethane bond. Rubber elasticity may be obtained even in the absence of a urethane bond.

In the first embodiment, it is sufficient that at least one of the hydroxyl groups of alkyl cellulose is substituted with an alkanoyl group and at least one selected from an acryloyl group and a methacryloyl group. In other words, the hydroxyl groups of the alkyl cellulose may be substituted with an acryloyl group and an alkanoyl group only, a methacryloyl group and an alkanoyl group only, or both an acryloyl group and a methacryloyl group and an alkanoyl group.

The hydroxy groups of the alkyl cellulose may be substituted with two or more alkanoyl groups selected from the propionyl group, the butyryl group, the pentanoyl group, the hexanoyl group, the heptanoyl group, the octanoyl group, the nonanoyl group, and the decanoyl group. Further, the hydroxy groups of the alkyl cellulose may be substituted with an alkanoyl group other than those described above. Any alkanoyl group may be used to produce a thermally conductive composition that is a solid having rubber-like elasticity or a solid having both fluidity and viscosity.

In the embodiments, the specific compound of the alkyl cellulose does not necessarily have to be hydroxypropyl cellulose. Any alkyl cellulose may be used to produce a thermally conductive composition that is a solid having rubber-like elasticity or a solid having both fluidity and viscosity.

The type of filler is not limited to that of the embodiments. It is only necessary that the thermal conductivity of the filler be greater than or equal to the thermal conductivity of the matrix.

The substitution degrees of the acryloyl group and the methacryloyl group are not limited to the values used in the embodiments. Also, the substitution degree of the alkanoyl group is not limited to the values used in the embodiments. The optimal substitution degree may vary depending on the type of functional group, whether an additive is used and the type of additive, and the producing method.

In the first embodiment, as in the thermally conductive compositions of Examples 1, 5, 7, and 11, the rubber hardness of the thermally conductive composition does not necessarily have to be less than or equal to 80. Even when the rubber hardness is greater than 80, if the thermally conductive composition is a solid having rubber-like elasticity, the thermally conductive composition may be used in the same manner as a thermally conductive composition in which the matrix is silicone.

In the first embodiment, as in the thermally conductive compositions of Examples 1 and 7, the thermal conductivity of the thermally conductive composition does not necessarily have to be greater than or equal to 0.5 W/m·K. Even when the thermal conductivity is less than 0.5 W/m·K, a thermally conductive composition that contains a biomass material may replace silicone, which may be used in a thermally conductive composition.

In the preparing step S11, any process may be used to prepare the predetermined cellulose derivative. The process for synthesizing the cellulose derivative may be omitted from the preparing step S11.

The type of additive added in the additive adding step S12 is not limited to that of the first embodiment. For example, when the thermally conductive composition is heated to be cured in the curing step S17, a thermal polymerization curing agent may be used in lieu of a photopolymerization initiator. When producing a thermally conductive composition paste, a curing agent does not necessarily have to be added.

The preliminary mixing step S13 may be omitted as long as the thermally conductive composition described in the embodiments is produced.

In the first embodiment, the stirring conditions in the preliminary mixing step S13 and the mixing step S15 are not limited to those of the first embodiment. The stirring conditions may be changed in accordance with, for example, the amount of the thermally conductive composition that is produced.

When producing a thermally conductive composition paste, the forming step S16 and the curing step S17 of the first embodiment may be omitted.

The method for curing the thermally conductive composition in the curing step S17 is not limited to that of the first embodiment.

The matrix may include both hydroxypropyl cellulose and ethyl cellulose as alkyl cellulose. Further, the matrix may include alkyl cellulose other than hydroxypropyl cellulose and ethyl cellulose.

The hydroxy groups of the alkyl cellulose may be substituted with two or more selected from the pentyloxy group, the hexyloxy group, the heptyloxy group, the octyloxy group, the nonanoyloxy group, and the decanoyloxy group as the alkoxy group. Further, the hydroxy groups of the alkyl cellulose may be substituted with an alkoxy group other than those described above. Any alkoxy group may be used to produce a thermally conductive composition that is a solid having rubber-like elasticity or a solid having both fluidity and viscosity.

The sum of the substitution degree of the acryloyl group and the substitution degree of the methacryloyl group may be any value greater than zero and thus may be less than 0.1 or greater than 0.6. The sum of the substitution degree of the acryloyl group, the substitution degree of the methacryloyl group, and the substitution degree of the allyl group may be any value greater than zero and thus may be less than 0.1 or greater than 0.6. The substitution degree of the alkanoyl group may be less than 2.0 or greater than 2.9. The substitution degree of the alkoxy group may be less than 2.0 or greater than 2.9. A thermally conductive composition that is a solid having rubber-like elasticity or a solid having both fluidity and viscosity may be produced regardless of the substitution degree.

### REFERENCE SIGNS LIST

S11 preparing step
S12 additive adding step
S13 preliminary mixing step
S14 filler adding step
S15 mixing step
S16 forming step
S17 curing step

1. A thermally conductive composition, comprising:
a matrix having a crosslinked structure; and
a filler dispersed in the matrix, wherein
a thermal conductivity of the filler is greater than or equal to a thermal conductivity of the matrix, and
the matrix includes a cellulose derivative in which at least one of hydroxyl groups of alkyl cellulose is substituted with an alkanoyl group and at least one selected from an acryloyl group and a methacryloyl group.

2. The thermally conductive composition according to claim 1, wherein a volume concentration of the matrix is 20 vol % to 60 vol %.

3. The thermally conductive composition according to claim 1, wherein a volume concentration of the filler is 40 vol % to 80 vol %.

4. (canceled)

5. The thermally conductive composition according to claim 1, wherein the cellulose derivative includes a urethane bond.

6. The thermally conductive composition according to claim 1, wherein the alkyl cellulose includes a monomer having three hydroxyl groups, and a sum of a substitution degree of the acryloyl group and a substitution degree of the methacryloyl group for the three hydroxyl groups is 0.1 to 0.6.

7. The thermally conductive composition according to claim 6, wherein the sum of the substitution degree of the acryloyl group and the substitution degree of the methacryloyl group for the three hydroxyl groups is 0.1 to 0.3.

8. The thermally conductive composition according to claim 6, wherein the substitution degree of the acryloyl group is 2.0 to 2.9.

9. The thermally conductive composition according to claim 1, wherein the alkanoyl group includes at least one selected from a propionyl group, a butyryl group, a pentanoyl group, a hexanoyl group, a heptanoyl group, an octanoyl group, a nonanoyl group, and a decanoyl group.

10. The thermally conductive composition according to claim 9, wherein the alkyl cellulose includes a monomer having three hydroxyl groups, a substitution degree of the alkanoyl group for the three hydroxyl groups is 2.0 to 2.9.

11. The thermally conductive composition according to claim 1, wherein the filler comprises at least one material selected from aluminum oxide, magnesium oxide, zinc oxide, iron oxide, quartz, boron nitride, aluminum nitride, silicon carbide, aluminum hydroxide, and cellulose.

12. The thermally conductive composition according to claim 1, wherein the filler includes cellulose.

13. A method for producing a thermally conductive composition, the method comprising:
preparing a cellulose derivative in which at least one of hydroxyl groups of alkyl cellulose is substituted with an alkanoyl group and at least one selected from an acryloyl group and a methacryloyl group;
adding a liquid, as an additive, to the cellulose derivative, the liquid having a lower viscosity than the cellulose derivative;
mixing the cellulose derivative and the liquid to obtain a preliminary mixture;
adding a filler to the preliminary mixture of the cellulose derivative and the additive, the filler having a thermal conductivity that is higher than or equal to a thermal conductivity of the cellulose derivative; and
mixing the preliminary mixture and the filler.

14. The method according to claim 13, further comprising:
forming the thermally conductive composition to have a predetermined thickness; and
curing the thermally conductive composition.

15. (canceled)

16. The method according to claim 13, wherein the cellulose derivative includes a urethane bond.

17. The method according to claim 13, wherein the alkyl cellulose includes a monomer having three hydroxyl groups, and a sum of a substitution degree of the acryloyl group and a substitution degree of the methacryloyl group for the three hydroxyl groups is 0.1 to 0.6.

18. The method according to claim 13, wherein the alkanoyl group includes at least one selected from a propionyl group and a butyryl group.

19. The method according to claim 13, wherein the filler comprises at least one material selected from aluminum oxide, magnesium oxide, zinc oxide, iron oxide, quartz, boron nitride, aluminum nitride, silicon carbide, aluminum hydroxide, and cellulose.

20. The method according to claim 13, wherein the filler includes cellulose.

21. The thermally conductive composition according to claim 1, wherein the alkyl cellulose is at least one selected from hydroxypropyl cellulose and ethyl cellulose.

22. A thermally conductive composition, comprising:
a matrix having a crosslinked structure; and
a filler dispersed in the matrix, wherein
a thermal conductivity of the filler is greater than or equal to a thermal conductivity of the matrix, and
the matrix is a cellulose derivative in which at least one of hydroxyl groups of alkyl cellulose is substituted with an allyl group and an alkoxy group.

23. The thermally conductive composition according to claim 22, wherein the alkyl cellulose includes a monomer having three hydroxyl groups, a sum of a substitution degree of the allyl group for the three hydroxyl groups is 0.1 to 0.6.

24. The thermally conductive composition according to claim 22, wherein the alkoxy group includes at least one selected from a pentyloxy group, a hexyloxy group, a heptyloxy group, an octyloxy group, a nonanoyloxy group, and a decanoyloxy group.

25. The thermally conductive composition according to claim 22, wherein the alkyl cellulose includes a monomer having three hydroxyl groups, and a substitution degree of the alkoxy group for the three hydroxyl groups is 2.0 to 2.9.

26. The thermally conductive composition according to claim 22, wherein the alkyl cellulose is at least one selected from hydroxypropyl cellulose and ethyl cellulose.
